(19) United States
(12) Patent Application Publication
(10) Pub. No.: US 2004/0215760 A1
(43) Pub. Date: Oct. 28, 2004

(54) Device for the control of heterogeneous equipment in a telecommunication network

(75) Inventors: Patrick Bergeot, Antony (FR); Bertrand Lapraye, Gif Sur Yvette (FR); Pascal Villeret, Calmart (FR); Michel Chevanne, Clamart (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/766,834

(22) Filed: Jan. 30, 2004

(30) Foreign Application Priority Data
Jan. 31, 2003 (FR) 03 01 102

(51) Int. Cl. G06F 15/173

(52) U.S. Cl. 709/223

(57) ABSTRACT

A management device or arrangement (D) for a communication network which includes a multiplicity of network equipment elements, each associated with a primary data management protocol, includes, firstly, mediation means (MM) coupled to equipment elements and to functional interface means (MIF) and with system interface means (MIS) coupled to a network management system (NMS), and secondly protocol adaptation modules (Pa-j), in number at least equal to the number of management protocols associated with the equipment elements. The protocol adaptation modules (Pa-j) are each charged i) with converting the primary data coming from an equipment element (NE-ij) in accordance with a management protocol, into secondary data adapted to the mediation means (MM), and ii) to convert the secondary data, which are intended for an equipment element (NE-ij), into primary data in accordance with a management protocol adapted to this equipment. In addition, these mediation means (MM) are configured, when they receive primary or secondary data, to determine the associated equipment (NE-ij), and then to feed the protocol adaptation module (PA-j) corresponding to the determined equipment, in order that it will perform the data conversion.

The invention concerns the domain covering the control of equipment (or equipment elements) in a communication network using a network management system.

Communication networks are generally equipped with a Network Management System (NMS), or network operating system, which is used by their manager (or supervisor) to manage the equipment (or equipment elements) of which they are composed, and which are incapable of doing so themselves. To this end, an integrated network management system NMS is either coupled to applications which implement functions and services, also known as Operations, Administration, Maintenance and Provisioning (OAM&P). Of these tools, we can in particular mention the Element Management System (EMS) which is responsible for providing the dialogue interface between the network equipment and the network management system NMS.

By “network equipment” is meant here any type of equipment, such as servers, terminals, switches, routers or concentrators, capable of exchanging data, and control or management equipment in particular, in accordance with a network management protocol, with the network management system NMS, such as the Simple Network Management Protocol (SNMP) for example (RFC 2571-2580), used in particular in ADSL-type networks, the TL1 protocol used in particular in the SONET-type networks, the Q3 protocol used in particular in the SDH-type networks, or indeed the CLI and CORBA protocols.

Because of their architecture, the current element management systems (EMS) act as a dialogue interface only for equipment (or equipment elements) associated with a given management protocol. Furthermore, the current element management systems act as dialogue interface only for network management systems of a given type, associated with a given management protocol.

The ever-increasing heterogeneity of network equipment and of the associated management protocols therefore imposes the putting in parallel of element management systems (EMS) between the network management system (NMS) and the various equipment elements. This facilitates neither the task of the network designers nor that of the network managers.

Moreover, each time a new management protocol appears within a network, it is necessary to design a new element management system EMS, and then to adapt the network management system (NMS) so that it is able to dialogue with it. This frequently takes several months of development, and significantly increases the cost of managing a network.

Apart from this, each time that one of these element management systems (EMS) in a network goes faulty, the network management system (NMS) is no longer able to dialogue with the equipment for which it is providing the dialogue interface.

Finally, when a new network management system (NMS) appears, it is generally necessary to develop new element management systems (EMS) for it.

The aim of the invention is therefore to remedy all or part of the above mentioned drawbacks.

To this end, it proposes a management or control device or arrangement, for a communication network consisting of a multiplicity of network equipment elements, each of which is associated with a primary data management protocol, where this device or arrangement includes mediation means which are coupled firstly to the equipment, and secondly to functional interface means and to system interface means, which themselves are coupled to a network management system (NMS).

This device or arrangement is characterised by the fact that it includes protocol adaptation modules, in number at least equal to the number of management protocols associated with these equipment elements, and each responsible firstly for converting the primary data coming from an equipment element in accordance with a management protocol, into secondary data adapted to the mediation means (and therefore to the network management system (NMS)), and secondly to convert the secondary data, which are intended for an equipment element, into primary data in accordance with a management protocol adapted to this equipment, and by the fact that these mediation means are responsible, when they receive primary or secondary data, for determining the equipment associated with these data, and then for feeding the protocol adaptation module corresponding to the determined equipment in order that it will perform the data conversion.

In this way, it is possible to exchange management data (or information) between the mediation means and each of the equipment elements, independently of the management protocol associated with them. As a consequence, a single management device or arrangement acts as a dialogue interface between the equipment in a network and the management system (NMS) of this network. Such a management device or arrangement can therefore replace, with advantage, a multiplicity of element management systems (EMS).

According to another characteristic of the invention, the mediation means are capable, when they receive a request designating one of the equipment elements, of generating a Management Information Tree (MIT), representative in particular of the links of this designated equipment to other network equipment.

In this case, and when the device or arrangement also includes a configurable Graphical User Interface (GUI) coupled to its mediation means, then the latter are preferentially arranged, when they have finished generating the management information tree, so as to configure the graphical user interface according to the auxiliary data which are representative of the designated equipment. These auxiliary data come preferentially from description modules implanted within the management device or arrangement, and each associated with one of the equipment elements. Such description data modules can be composed of at least a descriptor, which preferably includes at least one program code file and at least one configuration file. These program code files preferentially include the first data designating a type to which a network equipment element belongs, or second data designating the definition of a Management Information Base (MIB) associated with an equipment element.

Preferentially, the graphical user interface and the mediation means are coupled by a bus of the CORBA type.

Apart from this, the functional interface means can be implanted in the management device or arrangement, and can include a provisioning interface which is responsible for extracting, on command, from the network management system (NMS) for example, management information concerning an equipment element and contained in the management information tree (MIT), in order to transmit them to this equipment. Such a provisioning interface preferentially includes program code files encapsulated in modules of the “north-plug” type (that is modules which provide upward communication (to the NMS)). It can also be capable of generating a communication channel dedicated to transportation of the chosen codes, of the ASCII type for example, between at least one connection socket and the mediation means.

In addition, the functional interface means can also include a supervision interface arranged in the form of a public interface of the IDL type, and responsible for allowing the network management system NMS to administer the equipment and to handle the alarms and events occurring in this equipment.

The system interface means can also be implanted in the management device or arrangement, and can include a navigation interface arranged so as to allow the network management systems (NMS) to monitor firstly the graphical user interface configured by the mediation means, and secondly said mediation means.

These system interface means can also include a persistence module allowing, under the control of the network management system NMS for example, the storage of certain information data contained in the management information tree (MIT) and relating to equipment associated with a chosen priority level. Such a persistence module includes in particular an Application Programming Interface (PAA), of the JDBC type in particular.

At least one among the mediation means, the configurable graphical user interface, the functional interface means, and the system interface means, and preferably all of them, is composed of program code files, in the Java language for example.

The invention also concerns a management server for a network management system, and a network equipment element, each equipped with a management device or arrangement of the type presented above.

The invention can in particular be implemented in all network technologies requiring to be managed, and in particular in transmission networks (of the WDM, SONET or SDH type for example), data networks (of the IP or ATM type for example) or speech networks (of the conventional, mobile, or NGN type for example).

Other characteristics and advantages of the invention will appear upon examination of the detailed description which follows and of the appended drawings, in which:

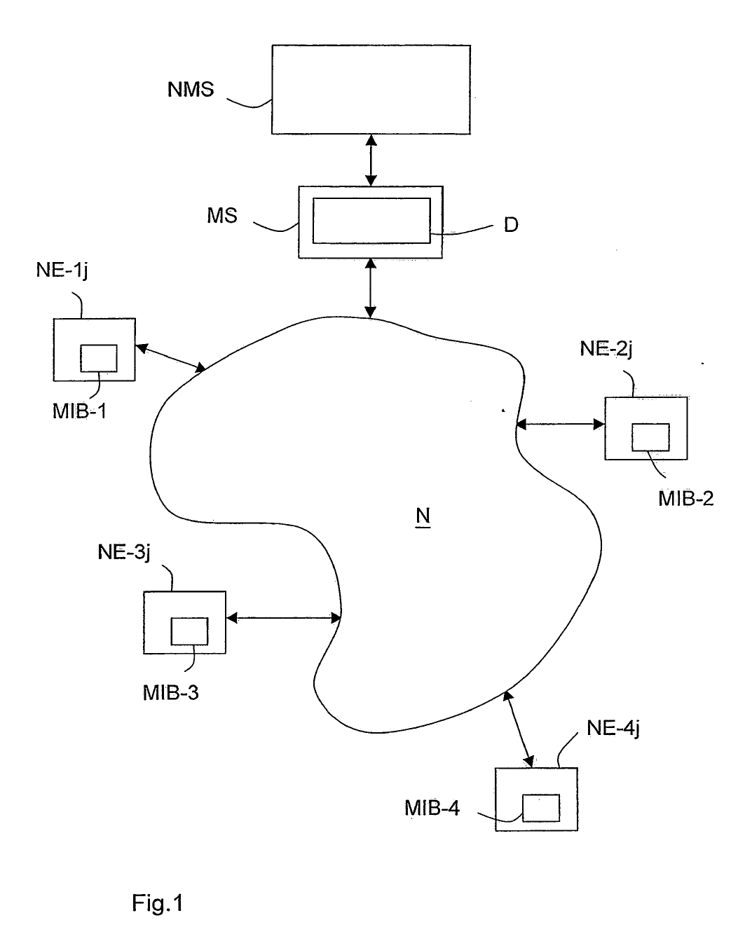

FIG. 1 illustrates in schematic fashion an example of a communication network equipped with a management device or arrangement according to the invention, implanted in a management server.

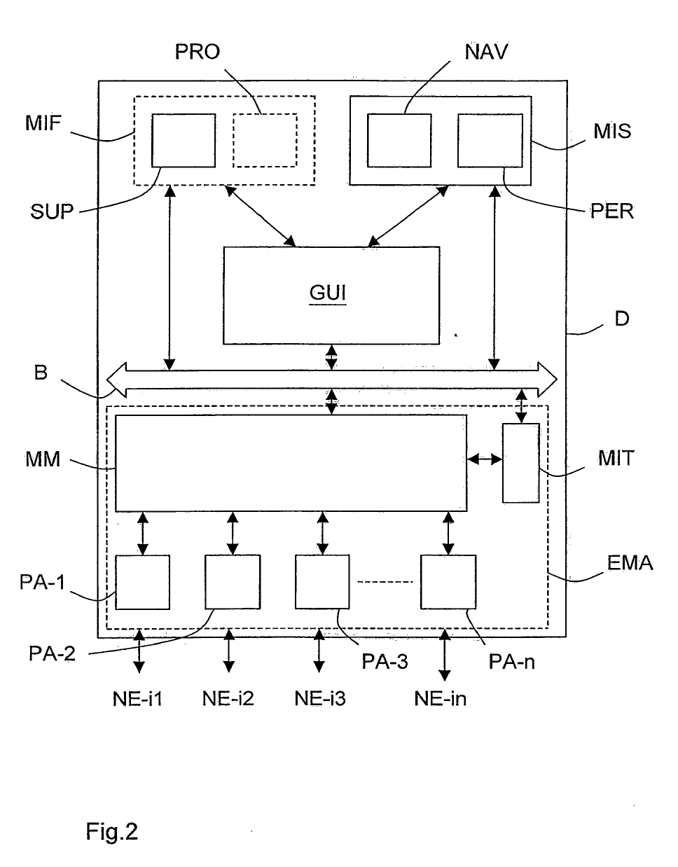

FIG. 2 illustrates in schematic fashion an example of the implementation of a management device or arrangement according to the invention, and

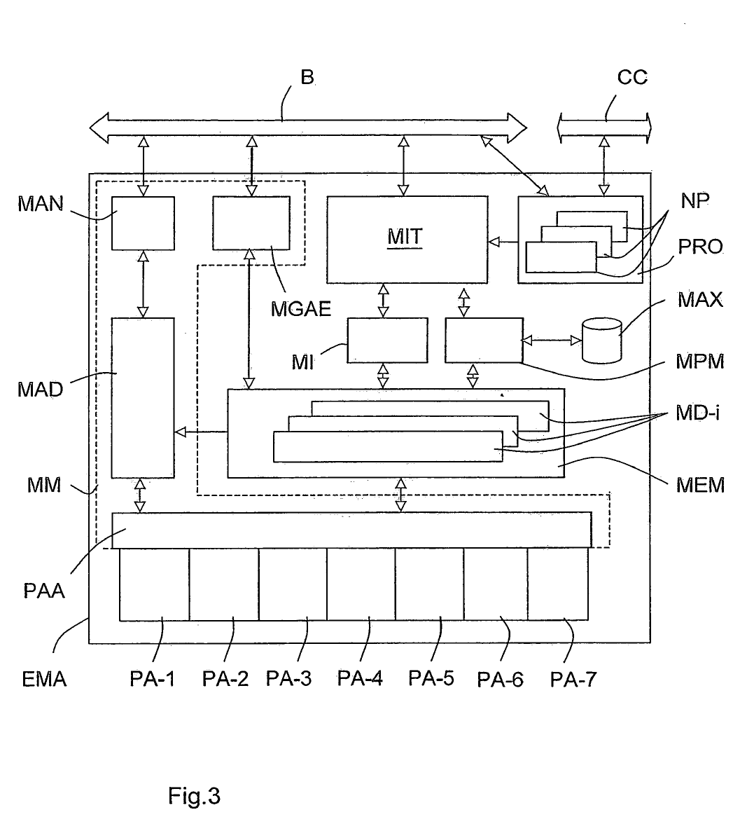

FIG. 3 schematically details the creation of a processing module (EMA) for the management device or arrangement illustrated in FIG. 2. This figure can not only serve to complete the invention but can also contribute to its definition, where appropriate.

As illustrated schematically in FIG. 1, a communication network N (here shown as a “balloon”) is composed of a multiplicity of network equipment elements (NE-ij—here, i=1 to 4, as an example), connected to each other by means of communication means, and a network management system (NMS) via a management server (MS). The network management system (NMS) is intended to enable the manager or supervisor of the network to remotely manage and monitor the equipment elements (NE-ij) to which he is coupled.

For example, the communication network (N) is at least partly of the Internet (IP) type. However, the invention also applies to other types of network, such as transmission networks of the WDM, SONET or SDH type, to ATM type data networks, or to conventional speech, mobile or NGN type speech networks.

By network equipment (NE-ij), one is referring here to any hardware capable of exchanging management data, referred to below as primary data, in accordance with a management protocol chosen with the management server (MS). As an example, these may be peripheral or core servers, terminals, switches, routers or concentrators.

The equipment can be grouped into families (j), each associated with a particular management protocol, such as the Simple Network Management Protocol (SNMP, RFC 2571-2580), for example, or the TL1, CORBA, CLI or Q3 protocols.

In order to allow a single management server (MS) to create a centralised dialogue interface function between the network management system (NMS) and the various equipment elements (NE-ij) of network N, the invention proposes a management device or arrangement (D) of the type illustrates in FIG. 2.

More precisely, in the example illustrated in FIG. 2, device D according to the invention includes a processing module (EMA) coupled via a bus (B), preferably of the CORBA type, to a graphical module of the graphical user interface (GUI) type, and to a functional interface module (MIF) and a system interface module (MIS). The system interface module (MIS) and the functional interface module (MIF) are also coupled to the graphical user interface (GUI) as well as to the network management system (NMS).

It is important to note that the graphical user interface (GUI) and/or the functional interface module (MIF) and/or the system interface module (MIS) may not be located at the same place as the rest of the device or arrangement. In fact, the processing module (EMA) can be located in a management server (MS) or in a network equipment element, while the graphical user interface (GUI) can be located in the network management system (NMS).

An example of implementation of the processing module (EMA) is illustrated in FIG. 3.

This processing module (EMA) includes a mediation module (MM) which is responsible for enabling the dialogue between the network interfaces (and those of the equipment elements in particular), coupled firstly to a management information tree (MIT) and secondly to protocol adaptation modules (PA-J, j=1 to n here), in number at least equal to the number of management protocols associated with the various families (j) of equipment elements (NE-ij) of network N.

The mediation module (MM) includes mainly an Alarm and Event Management Module (MGAE), an Equipment Administration Module (MAN), an Access Server Module (MAD) to access the description modules in a memory (MEM—to which we will return later), and an Application Programming Interface (PAA) coupled to the protocol adaptation modules (Pa-j).

The equipment administration module (MAN) is coupled to the CORBA bus (B) as well as to the access server module (MAD). In particular, it allows the network management system (NMS) to administer the equipment elements (NE-ij) with the assistance of the functional interface module (MIF) and the system interface module (MIS).

The alarm and event management module (MGAE) is coupled to the CORBA bus (B) and to the memory (MEM). In particular, it allows the network management system (NMS) to retrieve the information data representing the operational state of the equipment, and in particular the alarms and reports of events which have occurred in the equipment elements (NE-ij), in order to enable its management (by the triggering of suitable actions, for example).

The access server module (MAD) is the central element of the mediation module (MM). Its main function is described below.

Each protocol adaptation module (PA-j) is responsible, on an order from the access server module (MAD), for converting the primary data coming from an equipment element (NE-ij), according to a management protocol, into secondary data adapted to the mediation module (MM), and reciprocally, to convert secondary data, intended for an equipment element (NE-ij), into primary data, according to a management protocol used by this equipment element.

In other words, each time that the network management system (NMS) wishes to send management data to an equipment element (NE-ij), it sends said data (in the form of secondary data) to the mediation module (MM), which determines the protocol adaptation modules (Pa-j) corresponding to this equipment element (NE-ij), using its access server module (MAD). In like manner, each time that an equipment element (NE-ij) transmits primary data intended for the network management system (NMS), then the processing module (EMA) receives these, and then transmits them to the access server module (MAD) so that it can determine the protocol adaptation modules (Pa-j) corresponding to this equipment element (NE-ij).

In order to perform this determination, the access server module (MAD) accesses Description Modules (MD-p) stored in the memory (MEM) of the processing module (EMA), each of which is associated with at least one element of an equipment element (NE-ij—such as an integrated circuit card for example, or a connection interface), and in particular designating the exchange protocol associated with said element.

These description modules (MD-p) are preferentially arranged in the form of what the professional calls descriptors. A descriptor is a computer module which contains all of the data necessary for management by the network management system (NMS) of at least one equipment element. Each dedicated descriptor (MD-p) is preferentially composed of at least a first program code file used to converse with interface equipment, a second file containing the data which describe the equipment type, and a third file containing the data which describe the definition of a Management Information Base (MIB), associated with an equipment element (NE-ij) of the type considered, and at least one configuration file, of the XML type for example, containing information used to manage an equipment type in the network.

A management information base (MIB) definition conforms to RFC 1213, for example, in the case of the simple network management protocol (SNMP), and generally describes, for the equipment element (NE-ij) concerned, all of its possible attributes, a data type (string, integer, etc.), the naming organisation, the text describing the equipment (or object), the access rights, the hierarchy of the objects (or equipment), and so on. The management information base (MIB) definitions are stored in the network management system (NMS) or in the processing module (EMA), and are each associated with a management information base (MIB-i), also called an Object Instance Base, stored in the corresponding equipment element (NE-ij). Each management information base (MIB-i) includes information fields whose specific values characterise the associated equipment element (NE-ij), and can be accessed by a navigation interface (NAV—to which we will return later).

The program code files of the descriptors (MD-p) are preferentially in the Java language, because of the ability of this language to load and unload computer code dynamically. However other languages can be used, such as Smalltalk, as long as these allow the dynamic loading and unloading of computer code.

Once the access server module (MAD) has determined, in the memory (MEM), the protocol associated with the equipment element (NE-ij), it then deduces from this the protocol adaptation modules (Pa-j) which corresponds to it, and then sends the received primary data and secondary data to this protocol adaptation modules (Pa-j), via the application programming interface (PAA), so as to convert these into secondary data in accordance with the management protocol used by the network management system (NMS), or into primary data, according to the management protocol used by the equipment element (NE-ij). The protocol adaptation modules (Pa-j) thus perform a syntactic translation, so to speak.

By “transmitting or sending the data (primary or secondary) to a protocol adaptation module (PAM)” is meant both the action of communicating the data to said module and the action of dynamically loading (in the computing sense of the term) the protocol adaptation module (PAM) into the mediation module (MM), and more precisely into the access server module (MAD), and then to execute it with the data.

In the example illustrated in FIG. 3, seven (7) protocol adaptation modules (PAM), PA-1 to PA-7, have been represented. Protocol adaptation modules PA-1 and PA-2, correspond, for example, to proprietary protocols X and Y. Protocol adaptation modules PA-3 to PA-7 correspond respectively, for example, to the CORBA, CLO, TL1, SNMP and Q3 protocols. All of these protocol adaptation modules (Pa-j) are preferentially coupled to the application programming interface (PAA).

Because of the cooperation between the protocol adaptation modules (Pa-j) and the mediation module (MM), it is therefore possible to exchange management data (or information) between the mediation module (MM) (and therefore the network management system (NMS)) and each of the equipment elements (NE-ij), independently of the management protocol associated with them. In other words, the protocol adaptation modules (PAM) perform the decoupling between the syntactic translation and the semantic operation. As a consequence, in order to integrate a new equipment family within the network, and then to manage it, it is only necessary to install into the processing module (EMA) a new protocol adaptation modules (Pa-j) corresponding to it, with no need to perform basic modifications, especially to the mediation module (MM) and the graphical user interface (GUI), or to add a new element management system (EMS) to the network.

In addition, when a new network management system (NMS) makes its appearance, it is no longer necessary to specifically design several element management systems (EMS). It suffices in fact to adapt the protocol adaptation modules (Pa-j) of the device or arrangement according to the invention, in accordance with the management protocol used by the new network management system (NMS).

Furthermore, because of the architecture proposed, the mediation module (MM) is now capable of “generating”, from a complete management information tree (MIT) stored in a memory of the processing module, a partial management information tree (MIT) which is representative of an equipment element, and in particular other equipment of the network to which it is connected.

It is also particularly advantageous that management device or arrangement D includes a graphical user interface (GUI) of the configurable type. In this case, the mediation module (MM), when it has finished generating the partial management information tree (MIT) corresponding to the equipment element (NE-ij) designated in a received request, can in fact configure the graphical user interface (GUI) so that it too is suitable for the management of the network management system (NMS).

This configuration is performed in accordance with the auxiliary data representing the equipment element (NE-ij), preferentially coming from the description modules (MD-p) contained in the memory (MEM).

Preferentially, the processing module (EMA) of the management module (D) (and in particular the mediation module (MM) and its protocol adaptation modules (Pa-j)) are created in the form of software modules, that is in the form of program code files. Still more preferentially, these program code files are in the Java language, because of the ability of this language to load and unload computer code in a dynamic manner. However other languages, such as Smalltalk, can be used as long as these allow the dynamic loading and unloading of computer code. And even more preferentially, the program codes comply with C Virtual Machine (CVM) recommendations, where the letter C refers to the words “compact” and “connected”, the expression “consumer-oriented”, and the C language, so as to allow the device or arrangement to be installed in the network equipment, including in a portable computer.

But of course the processing module (EMA) could equally well be created in the form of a combination of electronic circuits (or hardware modules) and software modules.

The functional interface module (MIF) is more particularly charged with the exchange of information with both the network management system (NMS) and the equipment element (NE-ij) via the processing module (EMA), and especially its mediation module (MM). It includes a supervision interface (SUP) which in particular is responsible for retrieving information coming from the equipment element (NE-ij) of the network, such as alarms and events for example, so as to communicate these to the network management system (NMS) in order to administer and manage said equipment. This information retrieval is conducted via the processing module (EMA), and in particular via its alarm and event management module (MGAE), and in the light of the description data contained in the descriptors (MD-p). As indicated previously, the administration of the equipment element (NE-ij) particularly concerns management of the topology of the network. This is carried out via the processing module (EMA), and in particular via its equipment administration module (MAN) and its access server module (MAD).

Certain information can also be retrieved automatically. To this end, the processing module (EMA) can include an interrogation or polling module (IM) coupled to the management information tree (MIT) and the memory (MEM), containing the description modules (MD-p), and responsible for interrogating, preferably in a cyclic manner, equipment (of the passive kind) which does not spontaneously supply information representing their operational status. This Interrogation Module (IM) can also be coupled to a memory of the “registration repository” type. Such an interrogation module (IM) is particularly useful in access networks which include a large amount of equipment and in passive networks.

The supervision interface (SUP) is preferentially arranged in the form of a public interface of the IDL type, preferably based on the T1M1 recommendations (Q816, X780 and M3120). In addition, the internal representation of alarms and events preferentially complies with the ITU X733 and X721 standards, in order to provide compatibility with the older management systems based on an older version of the Q3 management protocol.

Because of this type of supervision interface (SUP), the user is able to navigate freely from one application to the next as if it had only a single management element rather than several in parallel.

The functional interface module (MIF) also includes a provisioning or feeding interface (PRO) which, in particular, is charged with the transmission of information coming from the network management system (NMS)) to the equipment elements (NE-ij) and/or the processing module (EMA), as well as the making available of information contained in the management information tree (MIT) to the network management system (NMS). Such a provisioning interface (PRO) includes program code files which are preferentially encapsulated in what the professional calls north-plug type modules (NP). By means of this navigation interface, the user is able to construct a mediation which allow him firstly to specify which internal object is useful for a provisioning operation, such as the relevance of a port for example, and secondly to manipulate defined internal objects, such as requesting the connectivity status of a port for example, and thirdly to create a communication channel (CC) dedicated to the transportation of individual codes, of the ASCII type for example, between a connection socket and the processing module (EMA).

The provisioning interface (PRO) is shown in FIG. 2 by means of dotted lines, since, as illustrates in FIG. 3, it is preferentially integrated into the processing module (EMA). In this case, it is coupled to the management information tree (MIT) and to the CORBA B bus.

The system interface module (MIS) is more particularly responsible for the integration, or in other words the organisation, of the dialogue between the network management system (NMS) and device or arrangement D. It includes a navigation interface (NAV) which, in particular, is charged with managing the dialogue between the network management system (NMS) on the one hand, and the graphical user interface (GUI), configured by the mediation module (MM), and the processing module (EMA) on the other, via interfaces of the CDE or Tooltalk type, or message-oriented proprietary interfaces such as NAVCON for example, or indeed interfaces to the Internet standard. It is also possible to add a programming interface of the Java PAA type in order to further raise the integration level.

The graphical user interface (GUI) can be used in the “application” mode as well as in the “applet” mode, thus allowing its integration via a “web” type navigation.

The system interface module (MIS) also includes a persistency interface (PER) which is particularly charged with storage of the data of management information or profiles, extracted from the management information tree (MIT) and concerning equipment associated with certain priority levels or particular contexts defined by persistency policies. These management information data are preferentially stored in an auxiliary memory (MAX) of the processing module (EMA) by means of a connection module (MPM), also known as an MIT persistency tool installed in the processing module (EMA) and coupled to the description modules (MD-p). However the auxiliary memory (MAX) can also be external to the processing module (EMA), or even to the management server (MS). In particular, it can be a memory of the database type, such as MySQL, or indeed a memory of the “flat files” type.

This persistency interface (PER) preferentially includes, and in particular, an application programming interface (PAA), of the JDBC type for example, in order to allow integration with the existing relational databases.

Thanks to the invention, one only has to have correspondence between the management protocols used by the network equipment and the management protocol used by an network management system (NMS) in order to handle the dialogue between the network management system (NMS) and these equipment elements. As a result, the invention ensures total portability, both hardware and contextual, because of the decoupling between the syntactic decoding and the semantic operation offered by the protocol adaptation modules.

In addition, the invention is compatible with all types of network equipment and all types of hardware involved in network management.

The invention is not limited to the embodiments of the management device or arrangement (D) and the management server (MS) described above, just as an example, but in fact encompasses all of the variants which can be envisaged by the professional in the context of the following claims.

We have therefore described a management device or arrangement (D) in a management server of a network management system (NMS). However the management device or arrangement (D) can be installed in a network equipment element or in a terminal dedicated to the local management of equipment, also known as a “craft terminal”.

In addition, we have described a management device or arrangement (D) which includes a mediation module (MM), protocol adaptation modules (PAM), a management information table (MIT), a connecting bus (B), a graphical user interface (GUI), a system interface module (MIS) and a functional interface module (MIF). Nevertheless, the device or arrangement according to the invention can be implemented more simply if it includes at least one mediation module coupled with protocol adaptation modules.

1. A management device or arrangement (D) for a communication network (N) which includes a multiplicity of equipment elements (NE-ij), each associated with a primary data management protocol, said device or arrangement (D) including mediation means (MM) coupled to said equipment elements (NE-ij) and to functional interface means (MIF) and system interface means (MIS) coupled to a network management system (NMS), characterised in that it includes protocol adaptation modules (Pa-j) in number at least equal to the number of management protocols associated with said equipment elements, and each arranged i) to convert primary data, coming from an equipment element (NE-ij) in accordance with a management protocol, into secondary data adapted to said mediation means (MM), and ii) to convert secondary data, intended for an equipment element (NE-ij), into primary data in accordance with a management protocol adapted to said equipment element, and in that said mediation means (MM) are arranged, on receipt of the primary or secondary data, to determine the associated equipment element (NE-ij) and then to feed the protocol adaptation modules (Pa-j) corresponding to said determined equipment element.

2. A device or arrangement according to claim 1, characterised in that, on receipt of a request designating one of said equipment elements (NE-ij), said mediation means (MM) are arranged to generate a management information tree (MIT) which is representative of the links of said designated equipment element to other equipment elements in said network (N).

3. A device or arrangement according to claim 2, characterised in that said mediation means (MM) are arranged, after generating said management information tree (MIT), to configure a graphical user interface (GUI) in accordance with auxiliary data which are representative of said designated equipment element (NE-ij).

4. A device or arrangement in accordance with claim 2, characterised in that it includes said configurable graphical user interface (GUI)

5. A device or arrangement according to claim 3, characterised in that it includes description modules (MD-p), each associated with at least one of said equipment elements (NE-ij) and including said auxiliary data.

6. A device or arrangement according to claim 5, characterised in that each data description module (MD-p) is composed of at least one descriptor.

7. A device or arrangement in accordance with claim 6, characterised in that each descriptor is composed of at least one program code file and at least one configuration file.

8. A device or arrangement according to claim 7, characterised in that one of said program code files of a descriptor includes first data designating a type to which an equipment element (NE-ij) belongs, and another of said program code files of said descriptor includes second data designating a management information base definition associated with said equipment element (NE-ij).

9. A device or arrangement according to claim 3, characterised in that said graphical user interface (GUI) and said mediation means (MM) are coupled via a bus (B) of the CORBA type.

10. A device or arrangement according to claim 2, characterised in that it includes said functional interface module (MIF).

11. A device or arrangement according to claim 10, characterised in that said functional interface module (MIF) includes a provisioning module (PRO), arranged to as to extract on command management information concerning said an equipment element (NE-ij) and containing said management information tree (MIT), so as to send these to said equipment.

12. A device or arrangement according to claim 11, characterised in that said provisioning means (PRO) include program code files encapsulated in the north-plug type modules (NP).

13. A device or arrangement according to claim 11, characterised in that said provisioning means (PRO) are arranged to generate a communication channel (CC) dedicated to the transportation of chosen codes between at least one connection socket and said mediation means (MM).

14. A device or arrangement according to claim 11, characterised in that said functional interface means (MIF) include a supervision module (SUP) suitable for allowing said network management system (NMS) to administer said equipment elements (NE-ij), and to handle the alarms and events coming from said equipment elements (NE-ij) via said mediation means (MM).

15. A device or arrangement according to claim 14, characterised in that said supervision module (SUP) is arranged in the form of a public interface of the IDL type.

16. A device or arrangement according to claim 1, characterised in that it includes said system interface means (MIS).

17. A device or arrangement according to claim 16, characterised in that said system interface means (MIS) includes a navigation module (NAV) arranged to allow said network management system (NMS) to control said graphical user interface (GUI) and said mediation means (MM).

18. A device or arrangement according to claim 16, characterised in that said system interface means (MIS) include a persistency module (PER) which is arranged so as to allow the storage in memory of certain information data contained in said management information tree (MIT) and relating to the equipment elements (NE-ij) associated with a chosen level of priority.

19. A device or arrangement according to claim 18, characterised in that said persistency module (PER) includes an application programming interface (PAA)

20. A device or arrangement according to claim 19, characterised in that said application programming interface (PAA) is of the JDBC type.

21. A device or arrangement according to claim 1, characterised in that at least one of said mediation means, the graphical user interface Module (GUI), the functional interface means (MIF) (MM) and the system interface means (MIS) is composed of program code files.

22. A management server (MS) for a network management system (NMS), characterised in that it includes a management device or arrangement (D) according to claim 1.

23. A network equipment element (NE-ij), characterised in that it includes a management device or arrangement (D) according to claim 1.

24. Use of the management device or arrangement (D), the management server (MS), and the network equipment (NE-ij) according to claim 1, in the network technologies which are to be managed.

25. Use according to claim 24, characterised in that said network technologies are chosen from a group which includes transmission networks, of the WDM, SONET and SDH types in particular, of data of the Internet-IP and ATM type in particular, and speech of the conventional, mobile and NGN type in particular.
